(19) United States
(12) Patent Application Publication
(10) Pub. No.: US 2003/0230628 A1
(43) Pub. Date: Dec. 18, 2003

(54) Computerized solicitation machine

(76) Inventors: Tony C. Mobley, Gary, IN (US); Dwight N. Taylor, Gary, IN (US)

Correspondence Address: Lee, Mann, Smith, McWilliams,, Sweeney & Ohlson, P.O. Box 2786, Chicago, IL, 60690-2786, US

(21) Appl. No.: 10/173,044

(22) Filed: Jun. 17, 2002

(51) Int. Cl. G06F 17/00

(52) U.S. Cl. 235/375

(57) ABSTRACT

The invention described herein allows for the automated solicitation, collection and tabulation, of donations by a machine. The machine solicits the donations, accepts money in the form of paper and coin currency, or credit card or debit card, validates the currency deposited, and keeps a running total of the money deposited, and thanks the donor for the donation. The computerized solicitation machine may also be connected by a communication channel, such as a modem and telephone line or wireless phone, to a computer at a central location so that the donations may be monitored and tallied from a remote location.

### RELATED APPLICATION

This patent application claims priority from application No. 60/299,132 filed Jun. 15, 2001.

### BACKGROUND OF THE INVENTION

Organizations, particularly those of a charitable nature, often find need to solicit donations from the public. This is often done by placing people in public places where the people solicit donations from members of the public they encounter. Other organizations may find it necessary to solicit funds from members of their own organizations at places where their members gather, such as conventions and meetings. The computerized solicitation machine described herein provides an automated way for organizations to solicit funds without burdening their members with the work of soliciting. Such a machine can be placed in a public area, and solicit donations, as well as collect and tabulate the donations, 24 hours a day.

### SUMMARY OF THE INVENTION

The invention described herein allows for the automated solicitation, collection and tabulation, of donations by a machine. The machine solicits the donations, accepts money in the form of paper and coin currency, or credit card or debit card, validates the currency deposited, and keeps a running total of the money deposited, and thanks the donor for the donation. The computerized solicitation machine may also be connected by a communication channel, such as a modem and telephone line or wireless phone, to a computer at a central location so that the donations may be monitored and tallied from a remote location. This allows a central location to monitor multiple computerized solicitation machines and total the amount of the donations from each machine.

The central location can also contact the machine from a location remote from the machine and query the machine as to the running total of the money deposited. In such a manner, the central location can monitor or query the tally of a plurality of machines. The machine could also be set to contact the central location at set times or upon certain occurrences such as upon the deposit of a donation.

Thus the machine may be used in a method to solicit donations, the method including the steps of:

playing a message to encourage donations to a particular organization;

accepting the donations by a currency validator, coin validator, or magnetic card reader to read credit or debit cards;

totaling the donations made;

playing a message thanking the donor for the donation.

This disclosure describes a computerized solicitation machine that is capable of the following:

providing a message which will play continuously or at predetermined intervals to encourage people to insert money into the computerized solicitation machine as a donation to the sponsoring organization;

providing a coin validator and a bill validator to accept and recognize both coin and paper currency; or providing a magnetic card reader for accepting credit or debit cards.

providing software to allow the computerized solicitation machine to determine how much money has been deposited by the donor and to further keep a running total of donations deposited into the machine;

providing a prerecorded message thanking the donor for the donation upon deposit and validation of the money deposited; and

providing a connection to a computer network, allowing the computerized solicitation machine and the amount of money deposited therein to be monitored from any remote location.

The machine may be placed anywhere one desires to solicit donations, so long as a power source, such as household current is available to provide electricity to the machine. Alternatively, the machine may include its own power source, such as a battery, to provide the electrical power. It is preferred that the machine is placed in an area of high traffic so that more people may be encouraged to donate.

The machine is preferrably constructed so that an audio message is produced by the machine at periodic intervals. The message may be any message, but it is preferred that the message be one encouraging people who hear the message to interact with the machine and make a donation by depositing money. In some embodiments, it may be preferable to have the audio message to play continuously. For instance, one could have a ten minute message that tells the story of the organization or cause that is soliciting the donation. Periodically, within the ten minute message, donations might be solicited. If a donation is made, the message is interrupted and a thank you message played, at which point the ten minute message resumes. One will recognize that there are many variations of message possibilities, including the use of video. In such an embodiment, the machine includes a video screen and a video player, such as a videotape player, DVD, or other device for playing a video.

The computerized solicitation machine also includes a bill validator and a coin validator to accept, recognize, and count the money deposited. Alternatively, or in conjunction with the bill and coin validator, the machine could include a card reader to allow the acceptance of credit, debit, or other data encoded cards. Such an embodiment also includes a communication channel to allow the machine to contact credit card and debit card organizations to obtain authorization for the charge or debit, and to record the transaction. Once the donation is accepted, the machine plays a prerecorded thank you message. Internally, the machine keeps track of a running tally of the money deposited over a selected time period.

### BRIEF DESCRIPTION OF THE DRAWINGS

FIG. 1 is an example of one embodiment of the computerized solicitation machine.

FIG. 2 is a schematic outlining the operation steps and components involved with the computerized solicitation machine.

FIG. 3 is a generalized diagram of an alternate embodiment including capabilities.

### DETAILED DESCRIPTION OF THE PREFERRED EMBODIMENT

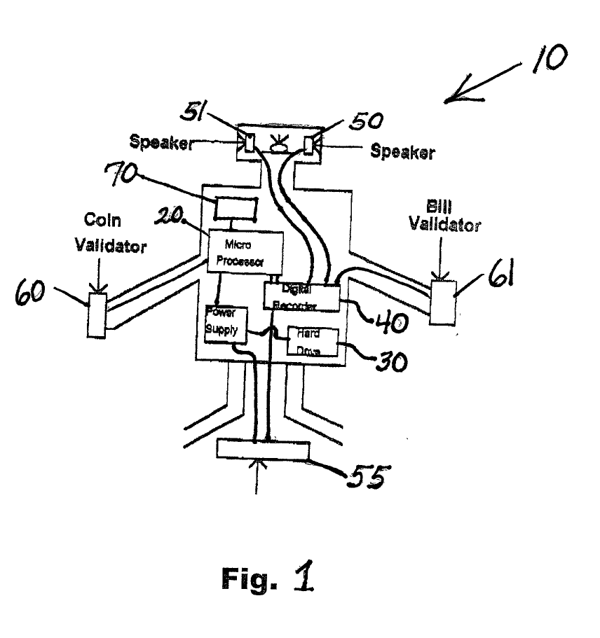

The computerized solicitation machine 10 can reside in any number of housings, such as a kiosk, a wall housing, or a mannequin, as shown in FIG. 1.

Central to the invention is a processor 20 and data storage device 30, such as a hard drive, DROM, electronic memory, or other devices commonly used in the computer industry to store information or programmings, the combination of which may provide the operating instructions for controlling the computerized solicitation machine 10. The computerized solicitation machine 10 also includes a digital recorder 40 for the playing of a message thanking the donor for the donation made. By digital recorder, the inventors are referring to any device that is capable of playing digitally recorded information. While this device commonly has the ability to record and play such as the hand held digital recorders presently offered by Sony, it is not necessary that the digital recorder include this ability. The digital recorder need only be capable of playing. Hence, the term digital recorder could also be replaced by digital player, without affecting the operation of the invention. It is also possible that other types of recorders could be used to play this message, such as an analog or digital magnetic tape recorder. In other embodiments, the message could be stored on the data storage device 30. A digital recorder could also be used to play the message encouraging the donation. However, in the preferred embodiment, software running on the computer controlling the machine provides this function. The computerized solicitation machine includes speakers 50 and 51 for the playing all of the messages.

The computerized solicitation machine includes a coin validator 60 and a bill validator 61 to accept and validate money deposited. The coin validator 60 and bill validator 61 are conncted electronicly to the microprocessor 20, so that the money deposited through the bill validator 61 or the coin validator 60 can be tracked by software running on the microprocessor 20. Additionally, the computerized solicitation machine 10 can include a modem 70, or other means by which the computerized solicitation machine 10 could communicate with other computers, preferably over telephone lines, or a worldwide computer network. The ability to connect to other computers allows one to monitor, from a remote location, the status of the monies deposited. By allowing a plurality of computerized solicitation machines to communicate with a central location, an entire network of machines can be used to solicit funds, and with the proper selection of coin and bill validators, donations are made in local currency. The amount deposited can then be converted to chosen currency via software running on the computerized solicitation machine or at the central location. This permits the central location to give a total for the amount deposited networkwide in any currency desired. Similarly, each machine may be equipped with bill validators and coin validators that could accept currency from a plurality of different countries.

In the preferred embodiment, the computerized solicitation machine 10 the microprocessor 20 is included in a computer capable of running the Windows '95 operating system, or the equivalent. The Windows '95 capable computer should include at least a 120 MHz processor as the microprocessor 10 and a 1.6 GB hard drive as the data storage device 30. A coin validator 60 and bill validator 61 are operably connected to the Windows '95 capable computer by the serial ports of the computer. An example of such a bill validator 61 is the GBA 12 V Stackerless Note Validator. An example of such a coin validator 60 is the Microcoin QL manufactured by Microsystems Controls. The digital recorder 40 for playing the audio messages is connected to speakers 50 and 51, or relies on its own internal speaker, so that a prerecorded message may play once money has been deposited in the coin validator 60 or bill validator 61. Power is provided to the components by a power distribution box 55, which itself draws power from a line current.

The bill validator 61 is also electrically connected to the play contacts of the digital recorder 40. Upon reception of a piece of paper currency, the bill validator 61 sends a signal to short the play contacts of the digital recorder 40, causing the digital recorder 40 to play a prerecorded message. The message played is one thanking the donor for the donation. In the preferred embodiment, the motor mechanism of the bill validator 61 goes to a low signal for a period of five milliseconds, and is electronically connected to the play contacts of the digital recorder 40. The five milliseconds duration low signal is sufficient to short the play contacts of the digital recorder 40, causing the digital recorder 40 to play the message. The bill validator 61 also interfaces with software running on the computer, allowing the software to keep track of the amount of money deposited in the computerized solicitation machine 10. In the preferred embodiment the software is provided by the manufacturer of the bill validator 61, although other software may be used.

The coin validator 60 is also connected to the play contacts of the digital recorder 40. When coins are deposited in the coin validator 60, it provides a five milliseconds pulse to the play contacts to cause the digital recorder 40 to play a predetermined message thanking the donor for the donation. To ensure the five milliseconds pulse returns to its original state after activating the digital recorder 40, a resistor diode configuration may be used for isolation. As one will recognize, there may be other ways to activate the recorder 40 as well as other devices used to play the desired message. The coin validator 60 also interacts with software running on the computer, allowing the software to keep track of the money deposited.

The Windows '95 capable computer can also include software to allow the computer and the computer solicitation machine 10 to be controlled remotely. One skilled in the art would recognize that a program such as PC Anywhere may be used to accomplish that goal. By the use of PC Anywhere, a person at a remote location could contact the computerized solicitation machine 10 via a communication channel such as a telephone line, and determine how much money has been deposited with the computerized solicitation machine 10. Under such a scheme, the person at the remote location, could contact a plurality of such computerized solicitation machines, to determine a total amount of money donated to the organization. In other embodiments, the computerized solicitation machine 10 could be configured to call into a central location periodically, and download its tally of the funds collected. Similarly, a plurality of other computers could contact a single machine, thus allowing monitoring of the machine by different people.

The Windows '95 capable computer also includes software to periodically play an audio message to encourage the donation of money. One will recognize that there are many ways a message can be played, including the use of a separate recorder or other playing device.

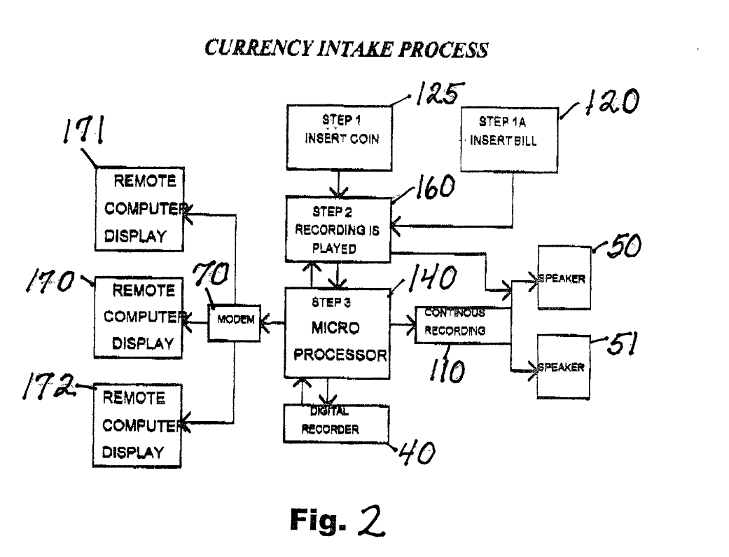

With reference to the operational outline of FIG. 2, in operation, the computerized solicitation machine 10 is placed in some public area preferably where there are many passersby. At a periodic interval, such as every five minutes, the computerized solicitation machine provide a predetermined message such as “please donate to the Needy Children's Fund”. The interval for playing the message can vary as desired, five minutes being only an example. The message could also be continuously played as shown in 110. In another embodiment, the machine could play a variety of messages. A person, passing by, upon hearing such a message, would be encouraged to provide a donation by placing money into the computerized solicitation machine. If a person placed paper currency into the bill validator, the bill validator would accept the currency and determine its value. Upon determining its value, it would record that amount in the software running on the Windows '95 capable computer 140. Also, the bill validator, upon insertion of the currency, would short the play contacts of the digital recorder 40, causing the digital recorder to play a message 160 thanking the user for the donation. Operation of coin deposits proceeds in a similar manner 125. At anytime during the operation, the computerized solicitation machine may contact other computers, 170, 171, 172 by a modem 70, allowing the other computers to monitor the amount of donations.

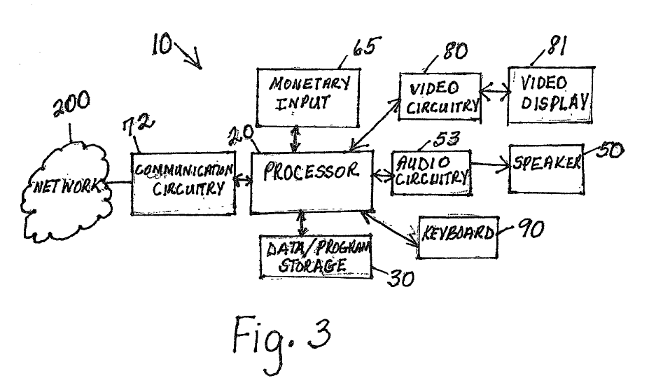

With reference to FIG. 3, an alternate embodiment utilizing a video display and keyboard is outlined. The processor 20 is connected to a monetary input 65, for accepting donations. The monetary input could be the aforementioned bill or coin validator, or a magnetic card reader or credit card processor for accepting electronically encoded cards. The processor is also connected to video circuitry 80 for driving a video display 81. The video display 81 is used to display a video presentation about the organization that is soliciting funds. Additionally, the video display could be used to allow the donor to have further interaction with the computerized solicitation machine such as a user has with an automated bank teller machine. For instance, the user could be presented with a menu displaying a plurality or organizations seeking donations. The user could then select from among the number of organizations and select one to donate to. Such interaction with the video display could be done via a touch screen, or utilize a separate keyboard 90 connected to the processor 20. The processor is also connected to audio circuitry 53 used to drive a speaker 50, for presenting audible information, such as the message soliciting donation, to the user or for presenting a thank you message. The processor is also connected to a data program storage 30 which stores both the data collected by the machine, as well as the programs used to run it, such as the programs controlling the video presentation, solicitation message, thank you message, and monetary input.

The processor 20 is also connected to communication circuitry 72 allowing the processor to communicate with a network 200. This activity allows the computerized solicitation machine 10 to communicate with computers located offsite, and provide information regarding the amount of donations to the other computers connected to the network 200.

The particular invention described herein is offered only by way of example, and is not meant to limit the scope of the invention described herein.

We claim

1. A machine for soliciting donations, the machine including:
a processor for controlling the machine;
a money acceptor for accepting the donation;
a player for playing a message soliciting a donation;
a player for playing a message upon the acceptance of a donation, the message thanking a donor for the donation.

2. The machine of claim 1, where the player for soliciting the donation is controlled by the processor.

3. The machine of claim 2, where the player for soliciting the donation is software running on the processor controlling the machine.

4. The machine of claim 1 where the player for thanking a donor is a digital recorder electrically connected to the money acceptor, the player being activated by the validation of money.

5. The machine of claim 1 where the player for thanking a donor is software running on the processor controlling the machine.

6. The machine of claim 5, where in the message thanking the donor plays after accepting the donation.

7. The machine of claim 1, further including a modem having access to a communications channel accessible by the processor, allowing the machine to communicate with a central location.

8. The machine of claim 4, where the money acceptor includes a bill validator.

9. The machine of claim 4, where the money acceptor includes a coin validator.

10. The machine of claim 4 where the money acceptor includes a magnetic card reader to read credit and debit cards.

11. The machine of claim 10 where the machine includes a modem having access to a communications channel accessible by the processor, allowing the machine to communicate with another computer.

12. A machine for soliciting donations, the machine including:
a processor for executing computer programs;
an electronic storage device for storing data or programs executable by the processor;
a money acceptor for accepting donations, the money acceptor being in communication with the processor;
a player for playing a message soliciting a donation; and
a player for playing a thank you message upon acceptance of a donation.

13. The machine of claim 12, where the player for soliciting a computer program executable by the processor.

14. The machine of claim 12 where the player for playing a thank you message is a digital recorder.

15. The machine of claim 12 where the player for playing the thank you message is activated by the money acceptor.

16. The machine of claim 12, further including communication circuitry in communication with the processor, the circuitry allowing the processor to communicate with another computer.

17. The machine of claim 12 further including a video display in communication with video circuitry in communication with the processor.

18. A method of soliciting donations including:
providing a computer capable of executing computer programs and communicating with a money acceptor;
providing a money acceptor;
playing a message soliciting donations;
playing a message thanking a donor upon the acceptance of money by the money acceptor.

19. The method of claim 18 where the message soliciting the donation includes a video message.

20. The method of claim 18, further including the step of tallying the total amount of money accepted by the money acceptor.
